(19) United States
(12) Patent Application Publication
(10) Pub. No.: US 2010/0322545 A1
(43) Pub. Date: Dec. 23, 2010

(54) SEALING ARRANGEMENT WITH AN INSTALLATION AID

(75) Inventors: Peter NIEBLING, BAD KISSINGEN (DE); Florian KOENIGER, SCHWEINFURT (DE); Wolfgang SEIDL, SCHWEINFURT (DE); Frank EICHELMANN, HASSFURT (DE); Peter PARTHEYMUELLER, MARKTGRAITZ (DE)

Correspondence Address: LUCAS & MERCANTI, LLP, 475 Park Avenue South, New York, NY, 10016, US

(73) Assignee: SCHAEFFLER TECHNOLOGIES GMBH & CO. KG, Schweinfurt (DE)

(21) Appl. No.: 12/816,846

(22) Filed: Jun. 16, 2010

(30) Foreign Application Priority Data
Jun. 17, 2009 (DE) 10 2009 025 129.4

(51) Int. Cl. F16C 33/76; F16J 15/32

(52) U.S. Cl. 384/484; 277/551

(57) ABSTRACT

A sealing arrangement for sealing rolling bearings. The sealing arrangement has a carrier ring for carrying an elastic part which has a radial sealing lip, and therefore a second ring which is movable relative to the carrier ring. The second ring has a cylindrical part provided as a radial seat for the radial sealing lip. A first installation aid is integrally formed on the radial sealing lip and prevents the radial sealing lip from becoming fixed on a second ring, such as, for example, a spinning ring, by ensuring that the radial sealing lip expands at the right time.

### FIELD OF THE INVENTION

The invention relates to a sealing arrangement for sealing rolling bearings, with a carrier ring for carrying an elastic part which has a radial sealing lip, and with a second ring which is movable relative to the carrier ring, wherein the second ring has a cylindrical part provided as a radial seat for the radial sealing lip. Furthermore, the invention relates to a rolling bearing with a sealing arrangement of this type.

A sealing arrangement of this type is used in conjunction with rolling bearings, in particular with wheel bearings, in order to seal off the rolling space thereof from external particles and also water, and therefore to guarantee that the rolling bearing has a long service life.

### BACKGROUND OF THE INVENTION

A person skilled in the art of rolling bearing technology is generally familiar with a multiplicity of sealed radial rolling bearings, in particular wheel bearings, which are composed substantially of an outer bearing ring and an inner bearing ring and of a multiplicity of rolling bodies which roll between the bearing rings and are held at uniform distances with respect to one another by means of a bearing cage. Said radial rolling bearings, in particular when used as wheel bearings in motor vehicles, have, in order to provide sealing against moisture and dirt, in each case one radially arranged carrier element between the bearing rings at both sides axially spaced apart from the rolling bodies, said carrier ring being provided with a radial sealing lip in order to carry an elastic part. A radial sealing lip comes into sliding contact with a cylindrical part of a second ring which may be, for example, a spinning ring.

The intention is to avoid the radial sealing lip bearing directly against a bearing ring which begins to rust undesirably over the course of the operating time and therefore leakages through rust infiltration may occur. Therefore, a second, substantially rustproof, second ring, which is rotatable relative to the carrier ring, is fixed on the inner ring so that a rustproof run-on surface is available for the radial sealing lip.

However, an installation problem which is not insignificant with regard to the service life of the radial rolling bearing occurs here. During the pressing-in operation of the second part, such as, for example, a spinning ring, it is conceivable that the radial sealing lip is not expanded in order to rest on a cylindrical part of the second ring but instead folds over in the axial direction toward the rolling body. Once this has taken place, the sealing arrangement can no longer meet the requirements imposed thereon, since the radial sealing lip is not supported as per operational requirements. Early penetration of dirt particles and moisture into the rolling space leads to a below average service life for the radial rolling bearing. Added thereto is the fact that a folding over of the radial sealing lip after installation cannot be seen from the outside and therefore also cannot be identified during a quality check. Therefore, this disadvantageously produced reject cannot even be identified as such.

### PRIOR ART

DE 10 2005 020 653 A1 discloses a sealed wheel bearing of a motor vehicle, which is composed of an outer bearing ring and an inner bearing ring and of a multiplicity of rolling bodies rolling between the bearing rings. Sealing arrangements are in each case provided between the bearing rings, both sides axially spaced apart from the rolling bodies. Said sealing arrangements contain a carrier ring with an elastic part and a spinning ring. The spinning ring sits on the inner ring, for example by means of a press fit, and at the same time provides a cylindrical surface for the radial sealing lip. Furthermore, the cylindrical part of the spinning ring has, facing the rolling bodies, a conical surface which assists the expansion of the radial sealing lip.

It has furthermore turned out that a sloping surface of this type requires a high outlay on material (cylindrical part is doubled), but nevertheless in many cases permits the radial sealing lip to fold over, the radial sealing lip still getting caught in front of the conical surface. This is the case, for example, whenever the rings are not guided sufficiently centrally axially to one another.

### OBJECT OF THE INVENTION

Starting from the drawbacks explained of the solutions known from the prior art, the invention is based on the object of providing a sealing arrangement for a radial rolling bearing, which can be produced cost-effectively and can easily be installed.

This object is achieved in the case of a sealing arrangement of the type mentioned at the beginning in that a first installation aid is integrally formed on the radial sealing lip.

According to the invention, a sealing arrangement for sealing rolling bearings is, with a carrier ring for carrying an elastic part which has a radial sealing lip, and with a second ring which is movable relative to the carrier ring, wherein the second ring has a cylindrical part provided as a radial seat for the radial sealing lip. The carrier ring and the second ring are also provided to be connected fixedly to one of the bearing rings of the rolling bearing. This may be undertaken, for example, by means of a press fit or the like. It does not matter here whether the outer bearing ring or the inner bearing ring is rotatable in relation to the other in each case.

The functioning of the sealing arrangement is based on a first installation aid which makes it possible to ensure that the sealing arrangement is securely and simply installed between the bearing rings. In comparison to known sealing arrangements, the axial installation force necessary to bring the carrier ring and second ring to the distance from each other as per operational requirements is advantageously significantly reduced.

The first installation aid and the radial sealing lip are advantageously both components of the elastic part which is produced, for example, from an elastomer. The first installation aid assists an expansion of the radial sealing lip in the radial direction in order to lift the latter over an initial piece of the cylindrical part of the second ring and to convey said sealing lip reliably into a radial seat on the cylindrical part.

In a first installation phase, the radial sealing lip initially bears against the inner ring. During an axial displacement toward the second ring, the first installation aid strikes against the cylindrical part of the second ring which is optionally beveled on the initial piece thereof or has a slope. During a continued axial displacement, the supported first installation aid causes the contact surface of the radial sealing lip, which contact surface is provided for the sliding seal, to be lifted off radially from the inner ring.

In a second installation phase, the contact surface of the expanded radial sealing lip, which contact surface is provided for the sliding seal, is placed onto the cylindrical part of the second ring and moves further thereon or on the slope thereof or bevel thereof in order to raise the radial expansion of the radial sealing lip to the radius as per operational requirements. During the course thereof, the first installation aid lifts fully off the cylindrical part of the second ring.

The first installation aid therefore ensures an expansion of the radial sealing lip, said expansion therefore not being caused exclusively by the cylindrical part of the second ring but rather by the latter in combination with the first installation aid. The radial sealing lip is already in an expanded state even before the contact surface thereof, which is provided for the sliding seal, strikes against the cylindrical part which optionally has a bevel or slope at the striking point. Folding over of the radial sealing lip in the direction of the rolling space is therefore avoided.

In an advantageous embodiment, the first installation aid has a larger internal radius than the contact surface. It is therefore possible to use the installation aid directly as an expansion instrument without having to expand the installation aid itself beforehand. Owing to the material-locking arrangement of the first installation aid and the radial sealing lip, the radial sealing lip is expanded as soon as the first installation aid strikes against the cylindrical part and itself undergoes expansion.

In an advantageous embodiment, the first installation aid has a slope or a rounded surface which is provided for radially expanding the radial sealing lip. In the case of a slope, an axial installation force is converted into a radial expansion of the first sealing lip. As an alternative, a rounded surface is also conceivable, said surface permitting optimum sliding on the cylindrical part of the second ring, if appropriate, assisted by a bevel on the cylindrical part, independently of the contact angle. The rounded surface affords the advantage that the axial sliding is optimally assisted during the installation irrespective of the bearing angle of the radial sealing lip, wherein the bearing point on the rounded surface changes as a function of the axial position of the carrier ring and the second ring with respect to each other.

The first installation aid advantageously does not touch any other component in the operating state of the sealing arrangement. This ensures that unnecessary friction, which would result in a loss of fuel, is not produced. Furthermore, it is possible to bring the first installation aid close to another component, such as, for example, to the second ring, to such an extent that a gap seal is formed, the gap seal protecting the radial sealing lip, or the sealing contact thereof between the contact surface and a surface of the cylindrical part, against dirt.

In an advantageous embodiment, the first installation aid is provided for interaction with the cylindrical part of the second ring during the installation operation. It is not ruled out here that the second ring, or the cylindrical part thereof, has a second installation aid, for example in the form of a slope or the like, with a conical surface. First and second installation aids therefore interact in order to significantly reduce the effort made during installation.

With a sealing arrangement according to the invention, a rolling space of a rolling bearing, in particular of a wheel bearing, for example of a motor vehicle, said rolling space containing rolling bodies, can be sealed.

Further advantageous developments and preferred refinements of the invention can be gathered from the description of the figures and/or the dependent claims.

### DESCRIPTION OF THE FIGURES

The invention is described and explained in more detail below with reference to the exemplary embodiments which are illustrated in the figures, in which;

FIG. 1 shows a sealing arrangement in a first installation phase with a contact surface of the radial sealing lip supported on the inner ring;

FIG. 2 shows a cutout of the radial sealing lip from FIG. 1;

FIG. 3 shows the sealing arrangement from FIG. 1 at the end of the first installation phase with a supported first installation aid and supported contact surface;

FIG. 4 shows a cutout of the radial sealing lip from FIG. 3;

FIG. 5 shows the sealing arrangement from FIG. 1 in the second installation phase with a supported contact surface;

FIG. 6 shows a cutout of the radial sealing lip from FIG. 5;

FIG. 7 shows the sealing arrangement from FIG. 1 in the operating state after installation; and

FIG. 8 shows a cutout of the radial sealing lip from FIG. 7.

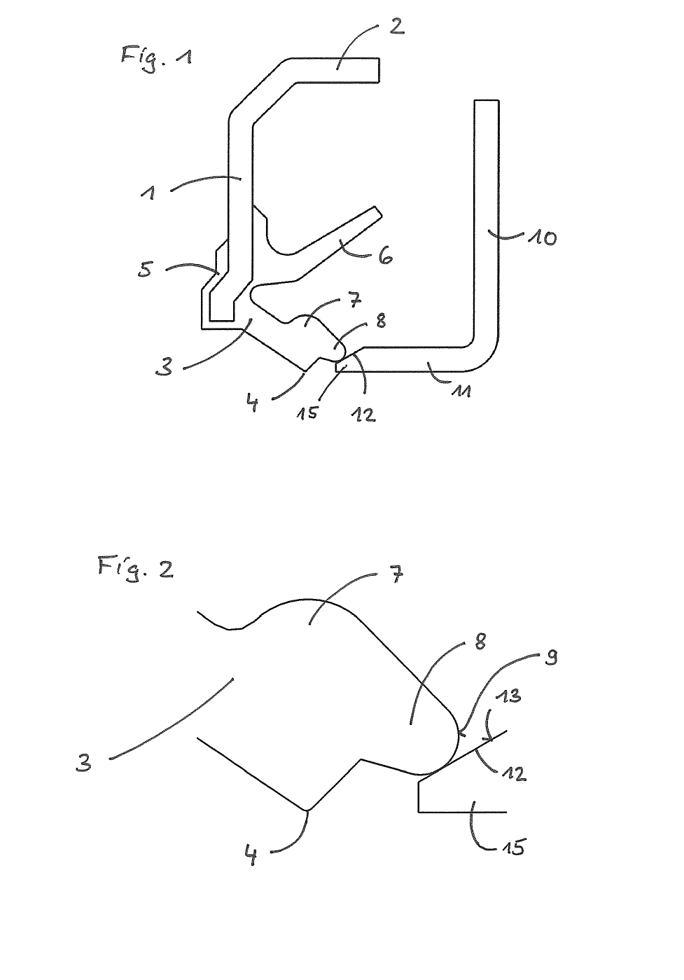

FIG. 1 shows a sealing arrangement in a first installation phase with a contact surface 4 of the radial sealing lip 3 supported on the inner ring. The load-bearing bearing rings are not depicted.

The installation operation can be carried out with a carrier ring 1 which is fastened to the outer ring via a fastening part 2, and with a second ring 10 which is fastened to the inner ring by means of a cylindrical part 11. In this case, the carrier ring 1, which forms a sealing ring together with the elastic part 5, and the second ring 10 are moved axially toward each other with respect to the axis of rotation of the rolling bearing.

The elastic part 5 here has an axial sealing lip 6 which, like the radial sealing lip 3, is prestressed in relation to the second ring 2 only in the course of the installation operation.

FIG. 2 shows a cutout of the radial sealing lip 3 from FIG. 1. The first installation phase is distinguished in that the radial sealing lip 3 is raised (expanded) radially by the integrally formed first installation aid and the rounded surface 9 thereof such that a contact surface 4, which is intended to produce the sliding sealing contact of the sealing arrangement with the cylindrical part 11 of the second ring 10, lifts off from the inner ring of the wheel bearing and is lifted over an initial piece 15 of the cylindrical part 11, irrespective of whether said part has or does not have a bevel 12.

The bevel 12 advantageously has a conical surface 13 which, in combination with the rounded surface 9, optimally reduces the frictional resistance during installation. This is possible because the first installation aid 8 is oriented away from the bead 7 partially in the radial direction and partially in the axial direction.

The bead 7 is provided to ensure that the contact surface 4 is relived of centrifugal force, and therefore the optimum sealing pressure can be ensured during operation. It is likewise advantageous for the conical surfaces which are adjacent to the contact surface 4 to be able to undertake a pure sealing function and therefore to be able to be shaped optimally, i.e. at the desired angle, with respect to the outer surface of the cylindrical part 11.

The first installation aid 8 advantageously forms a lug which is delimited by the round surface 9. As a result, it is possible always to ensure interference-free sliding irrespective of the angle of the radial sealing lip 3.

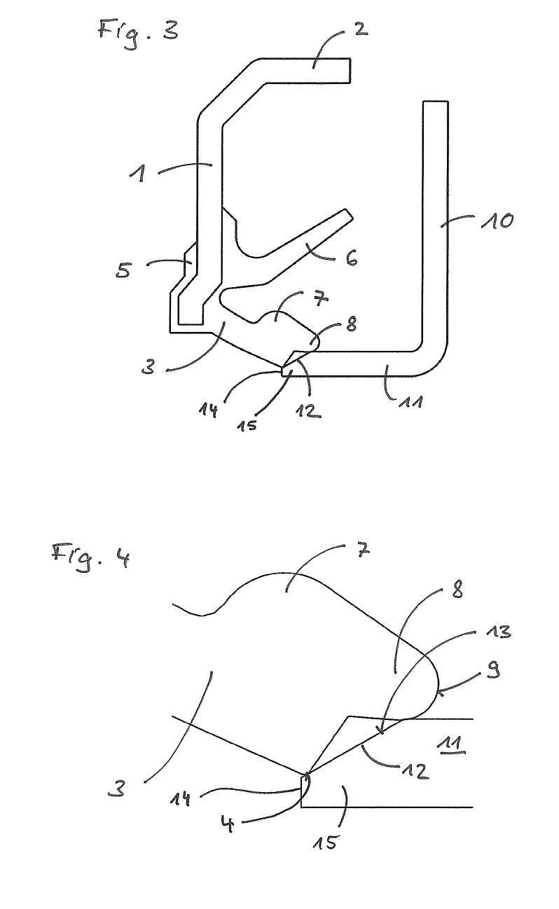

FIG. 3 shows the sealing arrangement from FIG. 1 at the end of the first installation phase with a supported first installation aid 8 and supported contact surface 4.

In this state, the contact surface 4 has advantageously already been placed on the cylindrical part 11, or on the bevel 12 thereof. Folding over is therefore ruled out because the non-beveled part of the annular end surface 14 of the initial piece 15 of the cylindrical part 11 has already been overcome.

Upon the carrier ring 1 and the second ring 10 being further brought together axially, the rounded surface 9 of the first installation aid 8 now lifts off the cylindrical part 11. From this time, the forthcoming expansion of the sealing lip 3 is brought about by means of the interaction between the bevel 12 and the contact surface 4.

FIG. 4 shows a cutout of the radial sealing lip 3 from FIG. 3.

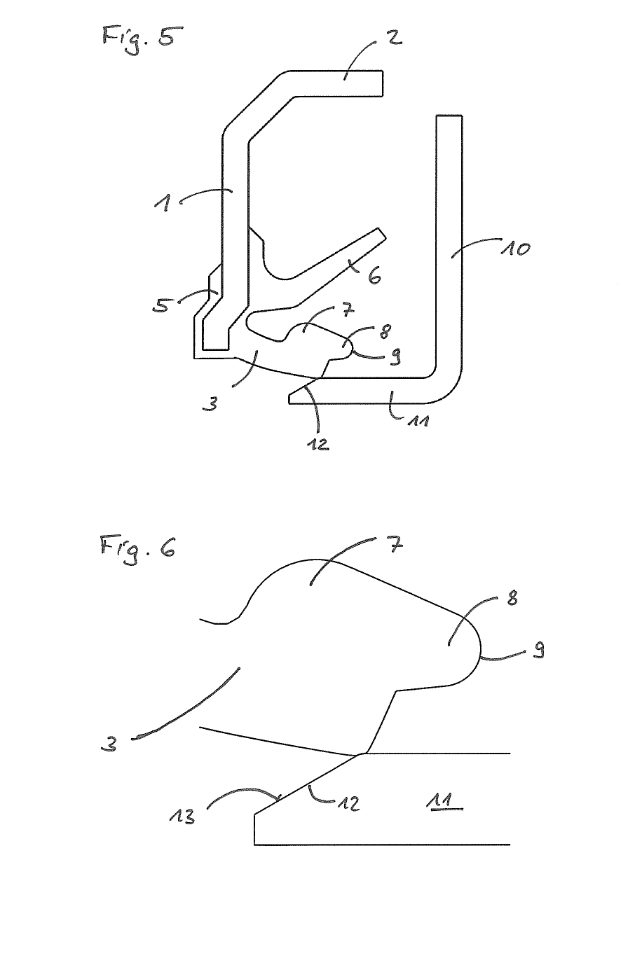

FIG. 5 shows the sealing arrangement from FIG. 1 in the second installation phase with a supported contact surface 4. The contact surface 4 has left the conical surface 13, is supported on the cylindrical surface of the cylindrical part 11 and can be readily pushed into the operating position thereof.

FIG. 6 shows a cutout of the radial sealing lip 3 from FIG. 5.

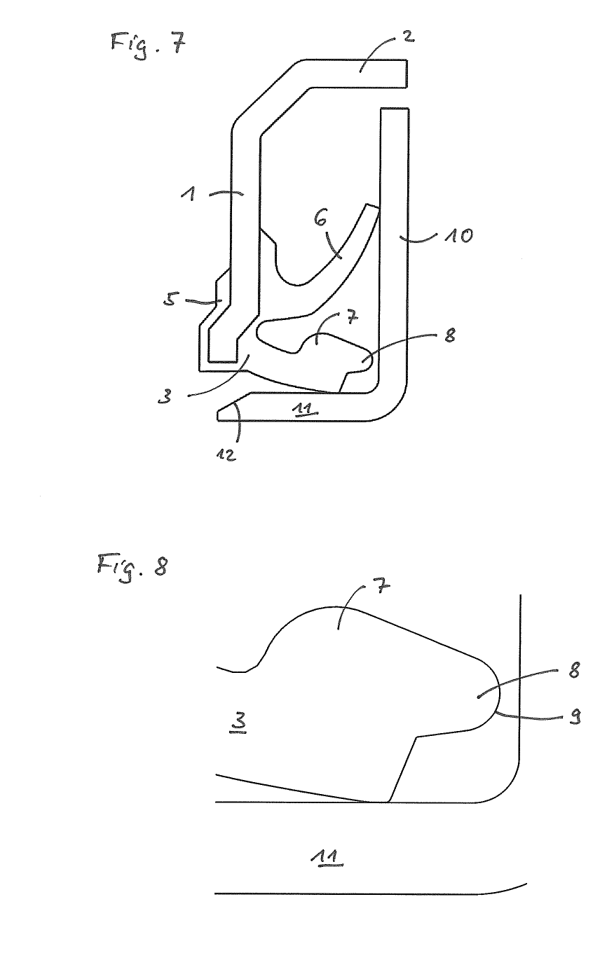

FIG. 7 and FIG. 8 respectively show the sealing arrangement from FIG. 1 in the operating position and the radial sealing lip 3 thereof in an enlarged cutout.

In summary, the invention relates to a sealing arrangement for sealing rolling bearings, with a carrier ring for carrying an elastic part which has a radial sealing lip, and therefore a second ring which is movable relative to the carrier ring, wherein the second ring has a cylindrical part provided as a radial seat for the radial sealing lip. The intention is to provide, on the basis of a sealing arrangement of this type, a teaching which avoids radial sealing lips folding over during the installation process without having to enter into compromises on the production costs or the coefficient of friction. For this purpose, a first installation aid is integrally formed on the radial sealing lip and prevents the radial sealing lip from becoming fixed on a second ring, such as, for example, a spinning ring, by ensuring that the radial sealing lip expands at the right time.

### LIST OF REFERENCE NUMBERS

1 Carrier ring
2 Fastening part
3 Radial sealing lip
4 Contact surface
5 Elastic part
6 Axial sealing lip
7 Bead
8 First installation aid
9 Rounded surface
10 Second ring
11 Cylindrical part
12 Bevel
13 Conical surface
14 End surface
15 Initial piece

1. A sealing arrangement for sealing rolling bearings, comprising:
a carrier ring for carrying an elastic part which has a radial scaling lip; and
a second ring which is movable relative to the carrier ring,
wherein the second ring has a cylindrical part provided as a radial seat for the radial sealing lip, and
wherein a first installation aid is integrally formed on the radial sealing lip.

2. The sealing arrangement of claim 1, wherein the first installation aid has a larger internal radius than a contact surface.

3. The sealing arrangement of claim 1, wherein the first installation aid has a slope or a rounded surface for radially expanding the radial sealing lip.

4. The sealing arrangement of claim 3, wherein the first installation aid does not touch any other component in an operating state of the sealing arrangement.

5. The sealing arrangement of claim 4, wherein the other component is the second ring.

6. The sealing arrangement of claim 5, wherein the first installation aid forms a gap seal together with the other component.

7. The sealing arrangement of claim 1, wherein the first installation aid interacts with the cylindrical part of the second ring during installation.

8. The sealing arrangement of claim 7, wherein the cylindrical part of the second ring has a second installation aid.

9. The sealing arrangement of claim 8, wherein the second installation aid has a bevel with a conical surface.

10. A wheel bearing, comprising:
rolling bodies in a rolling space; and
a sealing arrangement according to claim 1 for sealing the rolling space.
